(19) United States
(12) Patent Application Publication
(10) Pub. No.: US 2025/0094856 A1
(43) Pub. Date: Mar. 20, 2025

(54) SYSTEM AND METHOD FOR DETERMINING RESOURCE MISAPPROPRIATION USING AN ADVANCED COMPUTATIONAL MODEL FOR DATA ANALYSIS AND AUTOMATED DECISION-MAKING

(71) Applicant: BANK OF AMERICA CORPORATION, Charlotte, NC (US)

(72) Inventors: Sandeep Verma, Gurugram (IN); Pavan Chayanam, Alamo, CA (US); Nandini Rathaur, Worli (IN); Srinivas Dundigalla, Waxhaw, NC (US)

(73) Assignee: BANK OF AMERICA CORPORATION, Charlotte, NC (US)

(21) Appl. No.: 18/369,265

(22) Filed: Sep. 18, 2023

(51) Int. Cl. G06N 20/00

(52) U.S. Cl. CPC G06N 20/00

(57) ABSTRACT

Systems, computer program products, and methods are described herein for determining resource misappropriation using an advanced computational model for data analysis and automated decision-making. The present disclosure is configured to receive an interaction, wherein the interaction comprises a user and a caller; determine an instance of misappropriation during the interaction using an artificial intelligence model, wherein the instance of misappropriation comprises the caller attempting to collect sensitive information associated with the user; generate a misappropriation interface component, wherein the misappropriation interface component comprises data associated with the instance of misappropriation; and notify the user of the instance of misappropriation.

### TECHNOLOGICAL FIELD

Example embodiments of the present disclosure relate to determining resource misappropriation using an advanced computational model for data analysis and automated decision-making.

### BACKGROUND

There are many challenges associated with determining resource misappropriation during an interaction. Applicant has identified a number of deficiencies and problems associated with determining resource misappropriation using an advanced computational model for data analysis and automated decision-making. Through applied effort, ingenuity, and innovation, many of these identified problems have been solved by developing solutions that are included in embodiments of the present disclosure, many examples of which are described in detail herein

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for determining resource misappropriation using an advanced computational model for data analysis and automated decision-making.

Embodiments of the present invention address the above needs and/or achieve other advantages by providing apparatuses (e.g., a system, computer program product, and/or other devices) and methods for determining resource misappropriation using an advanced computational model for data analysis and automated decision-making. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention receives an interaction, wherein the interaction comprises a user and a caller. In some embodiments, the present invention determines an instance of misappropriation during the interaction using an artificial intelligence model, wherein the instance of misappropriation comprises the caller attempting to collect sensitive information associated with the user. In some embodiments, the present invention generates a misappropriation interface component, wherein the misappropriation interface component comprises data associated with the instance of misappropriation. In some embodiments, the present invention notifies the user of the instance of misappropriation.

In some embodiments, determining an instance of misappropriation further includes monitoring the interaction, wherein monitoring the interaction includes invoking a misappropriation detection module. In some embodiments, determining an instance of misappropriation further includes comparing the interaction with an interaction repository, wherein the interaction repository includes an authorized set of rules. In some embodiments, determining an instance of misappropriation further includes determining, in response to the caller attempting to collect sensitive information associated with the user, a misappropriation severity level.

In some embodiments, determining an instance of misappropriation further includes determining a misappropriation type.

In some embodiments, the authorized set of rules includes global rules, wherein the global rules comprise rules applicable to the interaction. In some embodiments, the authorized set of rules includes local rules, wherein the local rules comprise rules applicable to certain misappropriation types.

In some embodiments, the authorized set of rules may be updated by one or more entities.

In some embodiments, receiving the interaction further includes generating a finite state machine, wherein the finite state machine changes state in response to the misappropriation severity level. In some embodiments, receiving the interaction further includes restricting the user, wherein restricting the user includes limiting the user's ability to continue with the interaction. In some embodiments, receiving the interaction further includes generating a report, wherein the report includes data associated with the interaction, and wherein the report is transmitted to an entity associated with the user.

In some embodiments, the misappropriation interface component further includes configuring a graphical user interface associated with a user device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining resource misappropriation using an advanced computational model for data analysis and automated decision-making, in accordance with an embodiment of the disclosure;

FIG. 2 illustrates a process flow for determining resource misappropriation using an advanced computational model for data analysis and automated decision-making, in accordance with an embodiment of the disclosure.

FIG. 3 illustrates a process flow for determining a misappropriation severity level, in accordance with an embodiment of the disclosure.

FIG. 4 illustrates a process flow for an example application user interface, in accordance with example embodiments described herein.

FIG. 5 illustrates a process flow for an example process associated with example embodiments described herein.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “transfer,” a “distribution,” and/or an “allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

Fake call centers are a growing threat to legitimate entities and their customers. Currently, these call centers are operating from different countries where some entities do not have direct legal rights and remedies. Therefore, it is very difficult to investigate, detect, stop, and ensure the call centers are not repeating deceptive tactics in the future. The call centers collect sensitive information about entities (e.g., financial entities) and their customers from several sources, including but not limited to the Dark Web, data breaches, malicious software, and/or the like. Specifically, misappropriation attempts over the phone have become a growing and serious issue for customers attempting to protect their sensitive information.

Perpetrators of such misappropriation attempts are so well versed in committing misappropriation (e.g., financial misappropriations) that it is difficult for customers to determine if a phone call is a genuine call from a legitimate entity or from a perpetrator of a misappropriation.

In some embodiments, the misappropriation determination system may analyze an interaction (e.g., phone call) between a user (e.g., customer) and a caller. In some embodiments, the misappropriation determination system may use artificial intelligence, machine learning, natural language processing, and/or the like to analyze the call between the user and the caller. In some embodiments, if the caller is requesting sensitive information (e.g., date of birth, social security number, driver's license information, and/or the like) from the user, the misappropriation determination system may determine a misappropriation is taking place. In some embodiments, the misappropriation determination system may reference rules created by entities (e.g., financial institutions, businesses, corporations, and/or the like) associated with the misappropriation determination system, wherein the rules may be generally applicable to all phone calls and specific to certain phone calls. In some embodiments, the misappropriation determination system may update the user's device (e.g., cell phone) about the status of any potential misappropriations during the phone call. In some embodiments, the misappropriation determination system may alert the user, the entity associated with the user, the entity associated with the misappropriation determination system, and/or the like of any misappropriations detected during the phone call.

What is more, the present disclosure provides a technical solution to a technical problem. As described herein, the technical problem includes issues surrounding detecting, recognizing, mitigating, and counteracting misappropriations during an interaction. The technical solution presented herein allows for the detection, recognition, mitigation, remediation, and counteraction of misappropriations during an interaction. In particular, the misappropriation determination system is an improvement over existing solutions to remediating misappropriations during interactions, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and are directed to non-abstract improvements to the functionality of a computer platform itself. Specifically, the misappropriation determination system as described herein is a solution to the problem of detecting, recognizing, mitigating, and counteracting misappropriations during an interaction. Further, the misappropriation determination system may be characterized as identifying a specific improvement in computer capabilities and/or network functionalities in response to the misappropriation determination system's integration to existing devices, software, applications, and/or the like. In this way, the misappropriation determination system improves the capability of a system to determine resource misappropriations. Further, the misappropriation determination system improves the functionality of networks in response to reducing the resources consumed by the system (e.g., network resources, computing resources, memory resources, and/or the like).

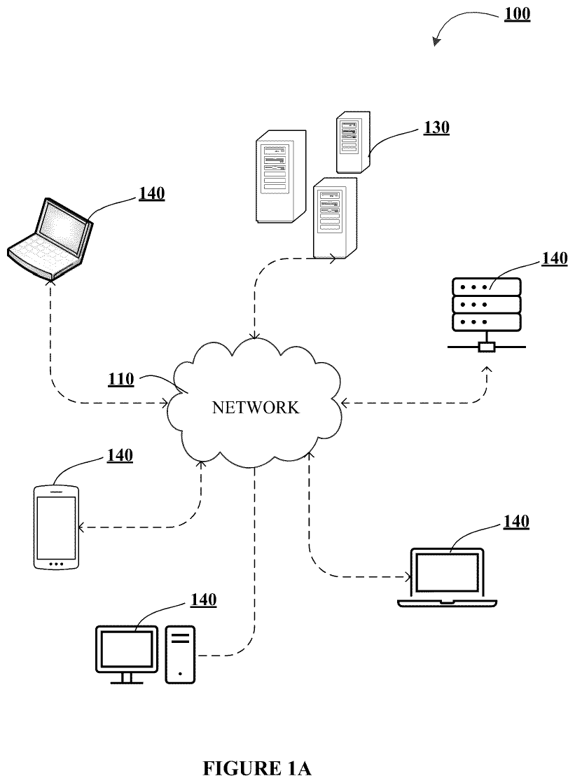

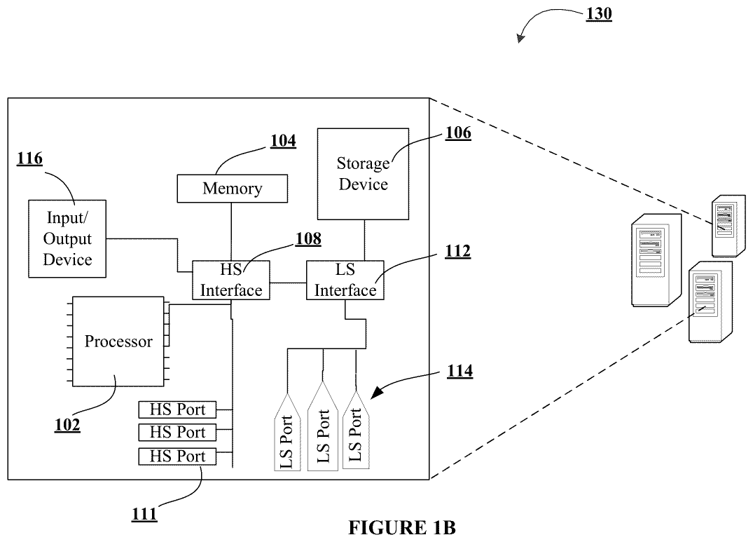

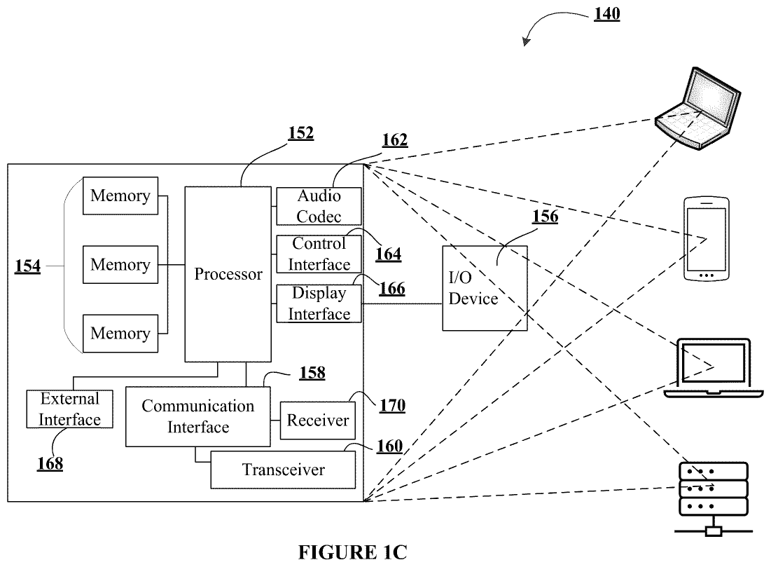

FIGS. 1A-1C illustrate technical components of an exemplary distributed computing environment 100 for determining resource misappropriation using an advanced computational model for data analysis and automated decision-making, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

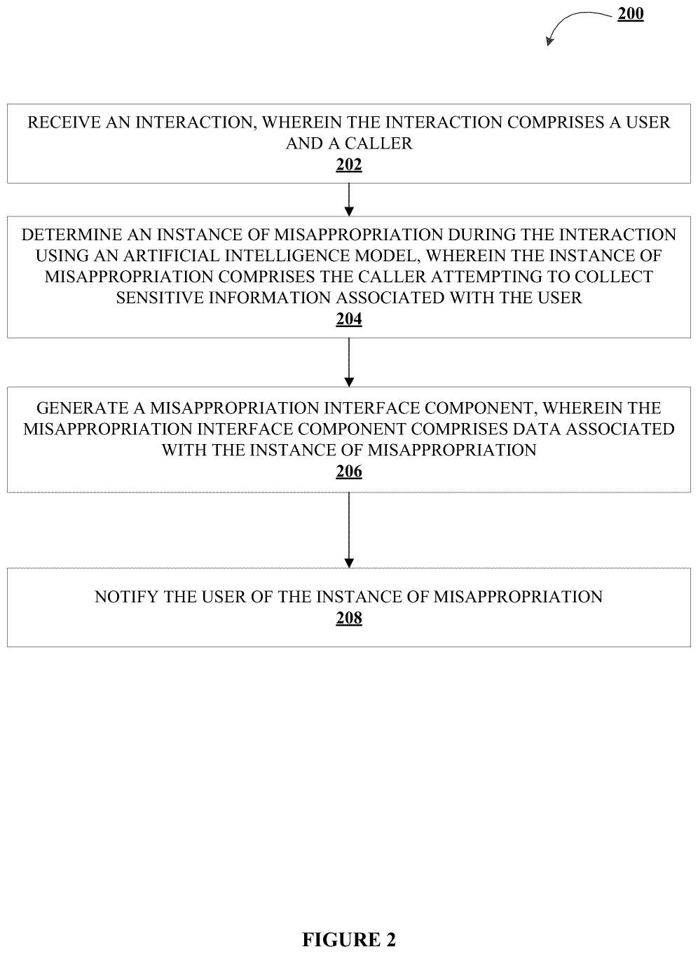

FIG. 2 is a process flow 200 which illustrates a process flow for determining resource misappropriation using an advanced computational model for data analysis and automated decision-making, in accordance with an embodiment of the disclosure. The method may be carried out by various components of the distributed computing environment 100 discussed herein (e.g., the system 130, or one or more end-point device(s) 140, etc.). An example system may include at least one processing device and at least one non-transitory storage device containing instructions that, when executed by the processing device, causes the processing device to perform the method discussed herein.

In some embodiments, a misappropriation system (e.g., similar to one or more of the systems described herein with respect to FIGS. 1A-1C) may perform one or more of the steps of process flow 200. For example, a misappropriation system (e.g., the system 130 described herein with respect to FIGS. 1A-1C) may perform the steps of process flow 200.

As shown in block 202, the process flow 200 of this embodiment includes receiving an interaction, wherein the interaction comprises a user and a caller. As used herein, the interaction may include any transmission of interaction, including, but not limited to, phone calls, text messaging, short message services (SMS), multimedia messaging services (MMS), video conferences, email messaging, voice messaging, video messaging, chat room messaging, social media direct messaging, online forums, collaboration tools, voice over internet protocol (VOIP) calls, broadcast messaging, facsimile, peer-to-peer (P2P) communications, and/or the like. In some embodiments, the interaction may include a phone call where the user is an individual is being targeted by the caller.

In some embodiments, the caller may be any person (e.g., individual, entity, and/or the like) that is communicating with the user. In some embodiments, the caller may be talking with the user over the phone, through video conferencing, over a VoIP call, through broadcast messaging, and/or the like. In some embodiments, the caller may be communicating through electronic communications, which may or may not include talking. For instance, and by way of non-limiting example, the caller may be texting (e.g., SMS, MMS, and/or the like), emailing, messaging (e.g., in a chat room, through social media, in an online forum, within collaboration tools, and/or the like) the user.

In some embodiments, the interaction may be between a user and what the user thinks is a legitimate employee (e.g., caller) of a legitimate corporation. In some embodiments, the user may be attempting to gain access to one of the user's accounts, updating account information, performing general account maintenance, and/or the like. For instance, and by way of non-limiting example, the user may be an unsuspecting user who is attempting to login to an old account. In this way, the user may be ready to provide information to the caller in order to gain access to the account. In some embodiments, the caller may be targeting the user at random. In this way, the caller may communicate (e.g., call, message, and/or the like) the user without prompt and/or without any previous interaction with the user. In some embodiments, the caller may pose as a legitimate entity (e.g., business, corporation, authority, government, and/or the like) in order to convince the user to give up the user's information.

In some embodiments, receiving the interaction includes generating a finite state machine, wherein the finite state machine changes state in response to the misappropriation severity level. In some embodiments, each interaction may have a separate finite state machine. In some embodiments, each state the finite state machine may take may have several attributes. For instance, and by way of non-limiting example, the state may include an “if, then” logic statement, wherein if the finite state machine reaches a particular state, then an alert (e.g., notification) may be played to the user to notify the user of a misappropriation attempt. In another instance, and by way of non-limiting example, the state may include muting the user when the user is attempting to expose sensitive information through the interaction. In some embodiments, the finite state machine may enable the user to report a misappropriation attempt with an entity.

In some embodiments, receiving the interaction includes restricting the user, wherein restricting the user comprises limiting the user's ability to continue with the interaction. As used herein, restricting the user may include blocking the user from communicating with the caller, muting or silencing the user, blocking the ability for the user to send messages, terminating the interaction, and/or the like. In some embodiments, restricting the user may include transmitting a warning signal to the user to notify the user that a misappropriation is taking place.

In some embodiments, receiving the interaction includes generating a report, wherein the report comprises data associated with the interaction, and wherein the report is transmitted to an entity associated with the user. In some embodiments, the report may include data associated with the caller, which may include data such as the caller's address (IP address, MAC address, geographic address, and/or the like), the caller's phone number, an institution the caller is associated with, and/or the like. In some embodiments, the data associated with the interaction may include the time and date of the interaction, the length of the interaction, a transcript of the interaction, a recording of the interaction, and/or the like. In some embodiments, the misappropriation determination system may analyze the interaction and tag instances of misappropriation in the report.

In some embodiments, the report may be transmitted to an entity associated with the user (e.g., a financial institution, or the like). In some embodiments, the entity may review the report. In some embodiments, the review may be an automated review, a manual review, or a combination of manual and automated review.

In some embodiments, the report may be used to train the artificial intelligence model. In this way, the report may contain an instance of misappropriation, which may provide information (e.g., training information) to the artificial intelligence model. In this way, the misappropriation determination system may continuously (e.g., in real-time) train the artificial intelligence model with interactions that may or may not contain misappropriation attempts.

As shown in block 204, the process flow 200 of this embodiment includes determining an instance of misappropriation during the interaction using an artificial intelligence model, wherein the instance of misappropriation comprises the caller attempting to collect sensitive information associated with the user. As used herein, the instance of misappropriation may include a misappropriation relating to the user's information. In some embodiments, the caller may be attempting to misappropriate some or all of the user's information. In some embodiments, the interaction may contain one or more instances of misappropriations. In this way, the misappropriation determination system may determine one or more instances of misappropriation during an interaction.

In some embodiments, an instance of misappropriation may include the caller requesting one or more pieces of information from the user. In this way, an instance of misappropriation may include one or more pieces of information from the user. For instance, and by way of non-limiting example, an instance of misappropriation may include a date of birth. In another instance, and by way of non-limiting example, an instance of misappropriation may include a date of birth and a social security number. In this way, the instances of misappropriation may include one or more pieces of information, as well as differing types of information.

In some embodiments, an instance of misappropriation may overlap (e.g., occur simultaneously, or the like) with another instance of misappropriation. For instance, and by way of non-limiting example, if a caller asks the user for the user's date of birth, the misappropriation determination system may indicate there are more than one instances of misappropriation. In this way, the misappropriation determination system may indicate the request for the date of birth as a misappropriation of the user's date of birth, as well as the misappropriation of the user's date of birth and social security number.

In some embodiments, the artificial intelligence model may analyze the interaction through a series of processes. For instance, and by way of non-limiting example, the artificial intelligence model may collect data from the interaction, annotate the data (e.g., label portions of the interaction), pre-process the data (e.g., segment the interaction, apply filters, improve clarity, and/or the like), perform speech recognition (e.g., convert speech into text), perform intent recognition (e.g., check the purpose of segments of the interaction), perform sentiment analysis (e.g., recognize the emotional tone of the interaction), perform entity recognition (e.g., identify specific entities associated with the interaction), and/or the like. In some embodiments, the artificial intelligence model may be trained specifically on recognizing misappropriation attempts by the caller to extract information from the user. In this way, the artificial intelligence model may be pre-trained on interactions that contain misappropriation attempts so the artificial intelligence model may recognize, analyze, and take action (e.g., restrict the user, or the like) when a misappropriation attempt happens.

As used herein, misappropriating may include collecting or gathering information through any form. In some embodiments, misappropriating may include disguising a request for information to dupe or trick the user into giving up information. In some embodiments, misappropriating may include requesting for the information directly.

In some embodiments, the caller may be attempting to misappropriate (e.g., collect) the user's information (e.g., sensitive information). In some embodiments, the information the caller is attempting to misappropriate may include information relating to the user's sensitive records. In some embodiments, the sensitive information of the user may include Personal Identifying Information (PII), financial information, health information, educational records, professional or employment related information, trade secrets, intellectual property, communication privacy, legal documents or information, credentials, and/or the like. In some embodiments, the sensitive information may include full names, social security numbers, driver's license information, passport information, date of birth, bank account details, credit or debit card numbers, personal identification numbers (PINs), and/or the like.

In some embodiments, determining an instance of misappropriation includes determining a misappropriation type. In some embodiments, the misappropriation type may include different types of misappropriation. In some embodiments, the interaction may include one or more types of misappropriation. In some embodiments, the misappropriation types may include an account takeover (AT), identity takeover (IT), card not present (CNP), interactive voice response (IVR) misappropriation, financial misappropriation (FM), sale, and/or the like. In some embodiments, the misappropriation type may represent the caller's objective during the interaction.

As shown in block 206, the process flow 200 of this embodiment includes generating a misappropriation interface component, wherein the misappropriation interface component comprises data associated with the instance of misappropriation. In some embodiments, the misappropriation interface component includes configuring a graphical user interface associated with a user device. In some embodiments, the user device may be the user device on which the user is performing the interaction. In some embodiments, configuring the graphical user interface of the user device may include transmitting one or more interaction characteristics, as discussed below. In some embodiments, the misappropriation determination system may configure the graphical user interface of an additional user device that is associated with the user. In this way, the user may perform the interaction on one user device while the misappropriation determination system updates a different user device during the interaction. For instance, and by way of non-limiting example, the user may take a phone call on the user's cell phone, but the misappropriation determination system may update the user's computer tablet during the interaction (e.g., update the computer tablet with the interaction characteristics).

As shown in block 208, the process flow 200 of this embodiment includes notifying the user of the instance of misappropriation. In some embodiments, the misappropriation determination system may notify the user of potential misappropriations (e.g., misappropriations that have not happened but have a probability of occurring), ongoing misappropriation (e.g., where the caller is collecting information from the user for a misappropriation), completed misappropriation (e.g., where the caller has collected the requisite information for a misappropriation), and/or the like.

In some embodiments, the notification may be transmitted during the interaction. In some embodiments, the notification may be transmitted after the interaction. In some embodiments, the notification may be transmitted both during and after the interaction.

In some embodiments, the notification may be transmitted to an entity associated with the user. In some embodiments, the notification may be transmitted to an entity the caller is portraying the caller is associated with. For instance, and by way of non-limiting example, if the caller states the caller is associated with a computer repair service, the misappropriation determination system may transmit a notification to the computer repair service upon detecting a misappropriation.

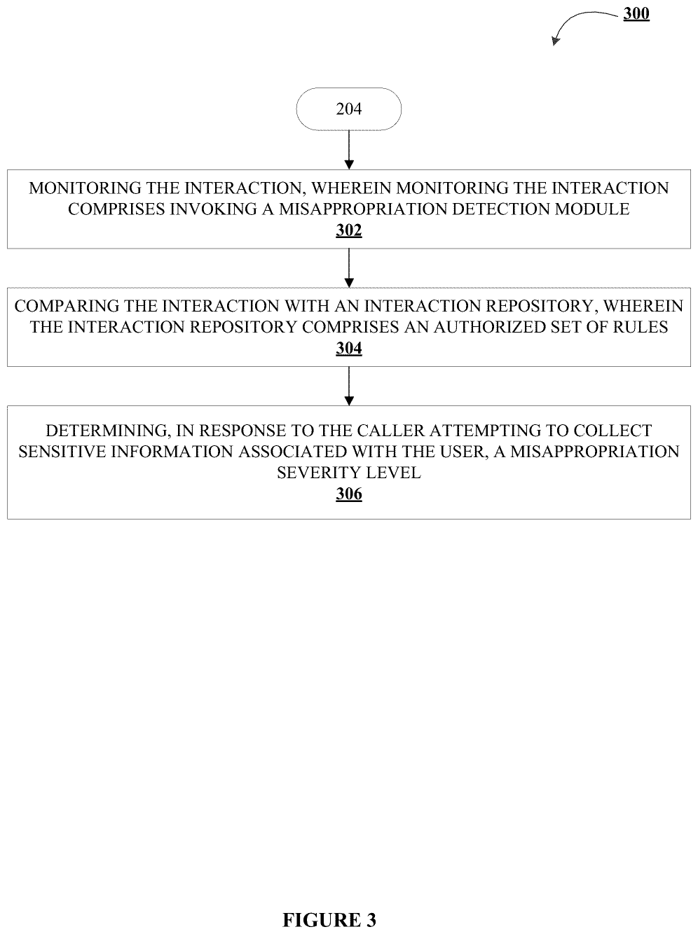

FIG. 3 is a process flow 300 which illustrates a process flow for determining a misappropriation severity level, in accordance with an embodiment of the disclosure. The method may be carried out by various components of the distributed computing environment 100 discussed herein (e.g., the system 130, or one or more end-point device(s) 140, etc.). An example system may include at least one processing device and at least one non-transitory storage device containing instructions that, when executed by the processing device, causes the processing device to perform the method discussed herein.

In some embodiments, a misappropriation system (e.g., similar to one or more of the systems described herein with respect to FIGS. 1A-1C) may perform one or more of the steps of process flow 300. For example, a misappropriation system (e.g., the system 130 described herein with respect to FIGS. 1A-1C) may perform the steps of process flow 300.

As shown in block 302, the process flow 300 of this embodiment includes monitoring the interaction, wherein monitoring the interaction comprises invoking a misappropriation detection module. In some embodiments, the misappropriation detection module includes monitoring the interaction, context parsing in real time of the interaction, and/or the like. In some embodiments, the misappropriation determination system may perform context parsing in real time by using natural language processing (NLP) to determine the structure and meaning of the interaction. In some embodiments, context parsing may include tokenization (e.g., breaking the interaction into individual words or tokens), speech tagging (e.g., assigning grammatical tags to each token), syntactic parsing (e.g., determining grammatical structure), semantic role labeling (e.g., determining relationships within the interaction), contextual analysis (e.g., determining context of particular word or phrase), and/or the like.

As shown in block 302, the process flow 300 of this embodiment includes comparing the interaction with an interaction repository, wherein the interaction repository comprises an authorized set of rules. In some embodiments, the authorized set of rules includes global rules, wherein the global rules comprise rules applicable to the interaction. In some embodiments, the global rules may be common (e.g., applied) to all types of interactions. In some embodiments, the global rules may be maintained, updated, added to, deleted, and/or the like by an entity associated with the misappropriation determination system.

In some embodiments, the authorized set of rules includes local rules, wherein the local rules include rules applicable to certain misappropriation types. In some embodiments, the local rules may be triggered upon certain phrases contained within the interaction. In some embodiments, the local rules may only apply to specific entities. For instance, and by way of non-limiting example, if an entity has a particular rule (e.g., never asking a user for a date of birth over a phone call), then a local rule may be triggered when a caller asks a user for the user's date of birth. In another example, a local rule may state a certain entity provides end-to-end encryption of the interaction, and if the interaction does not have end-to-end encryption, the local rule may fail.

In some embodiments, the finite state machine may determine its state in response to the global and local rules. In this way, the finite state machine may analyze whether the applicable rules have passed or failed to determine the state. For instance, and by way of non-limiting example, if the local rule concerning a user's date of birth has failed, the finite state machine may alert the user of an attempted misappropriation (e.g., notify the user through a warning beep, or the like).

In some embodiments, the authorized set of rules may be updated by one or more entities. In some embodiments, the local rules that are updated may only apply to the entity that updated them. In some embodiments, the global rules that are updated may apply to all entities associated with the misappropriation determination system. In some embodiments, the entities associated with the misappropriation determination system may agree upon any updates to the authorized set of rules.

As shown in block 302, the process flow 300 of this embodiment includes determining, in response to the caller attempting to collect sensitive information associated with the user, a misappropriation severity level. As used herein, the misappropriation severity level may include creating different severity levels to describe the different types of responses from the misappropriation determination system based on the misappropriation attempt (e.g., misappropriation type). In some embodiments, the misappropriation severity levels may include categorization from least to most severe. For instance, and by way of non-limiting example, the misappropriation severity levels may be categorized as minor, moderate, major, critical, and/or the like. In this way, the minor misappropriation severity level may include a minor issue to the user if the caller misappropriates the user's information. Further, the moderate misappropriation severity level may include a moderate issue to the user if the caller misappropriates the user's information (e.g., the user may be locked out of the user's accounts and need to reset passwords, or the like). Further still, the major misappropriation severity level may include a major issue to the user (e.g., a financial misappropriation, new accounts may be opened in the user's name, user accounts may be closed, and/or the like). Further still, the critical misappropriation severity level may include critical issues for the user (e.g., identity misappropriation, impacts to user's ability to interact with society, and/or the like).

In some embodiments, the misappropriation severity level may include configuring a graphical user interface, wherein the graphical user interface is associated with a user device. In some embodiments, the user device may be associated with the user (e.g., the user's cell phone, computer, tablet, smart watch and/or the like). In some embodiments, configuring the graphical user interface may include showing the user interaction characteristics, wherein the interaction characteristics may include the misappropriation type, a live interaction context analyzer, a sensitive information tracker, regular interaction options, and/or the like. In some embodiments, the interaction characteristics may be updated by the misappropriation determination system throughout the interaction. In some embodiments, the interaction characteristics may show the user the status of any misappropriation attempts throughout the interaction. In some embodiments, the user may interact with the interaction characteristics.

In some embodiments, the misappropriation determination system may transmit the interaction characteristics to the user during the interaction, after the interaction, or both during and after the interaction. In some embodiments, the interaction characteristics may be transmitted to the user through electronic means (e.g., phone call, text message, email, push notification, and/or the like), through physical means (e.g., letter in the mail, printable versions of the interaction characteristics, and/or the like), or a combination of electronic and physical means. In this way, the misappropriation determination system may notify the user about the potential misappropriation types, levels, and/or the like during or after the interaction.

In some embodiments, the misappropriation type may be represented in the graphical user interface during the interaction. In this way, the misappropriation determination system may show the user what type of misappropriation is being attempted in response to the interaction. In some embodiments, the misappropriation determination system may analyze what information has been requested (e.g., from the caller) and what information has been provided (e.g., from the user) to determine the misappropriation type. In some embodiments, the misappropriation type may be highlighted on the user device to indicate which misappropriation type has been detected by the misappropriation determination system.

In some embodiments, the live interaction context analyzer may be represented in the graphical user interface during the interaction. In this way, the misappropriation determination system may show the user the potential misappropriation level in response to the interaction. In some embodiments, the misappropriation determination system may aggregate the information it has collected throughout the interaction to determine the potential for misappropriation. In some embodiments, the potential misappropriation may be represented in a percentage form (e.g., 25%, 50%, 75%, 100%, and/or the like). In some embodiments, the potential misappropriation may be represented in other forms, such has using phrases (e.g., low chance, medium chance, high chance, and/or the like), symbols, characters, and/or the like.

In some embodiments, the sensitive information tracker may be represented in the graphical user interface during the interaction. In this way, the misappropriation determination system may show the user the sensitive information the user has revealed during the interaction. For instance, and by way of non-limiting example, in response to the user revealing the user's date of birth, the sensitive information tracker may show that the user's date of birth has been revealed. In some embodiments, the sensitive information tracker may keep track of the information revealed in real time throughout the entirety of the interaction.

In some embodiments, the regular interaction options may be represented in the graphical user interface during the interaction.

In some embodiments, the misappropriation determination system may update the interaction characteristics between one or more interactions. In this way, the misappropriation determination system may detect that a caller has interacted with the user on one or more occasions. In some embodiments, the misappropriation determination system may retrieve the previous interaction's interaction characteristics to show the user what information the user has already revealed, what misappropriation types were detected, the potential for misappropriation, and/or the like. In this way, the misappropriation determination system may determine misappropriation attempts between one or more interactions between a caller and a user.

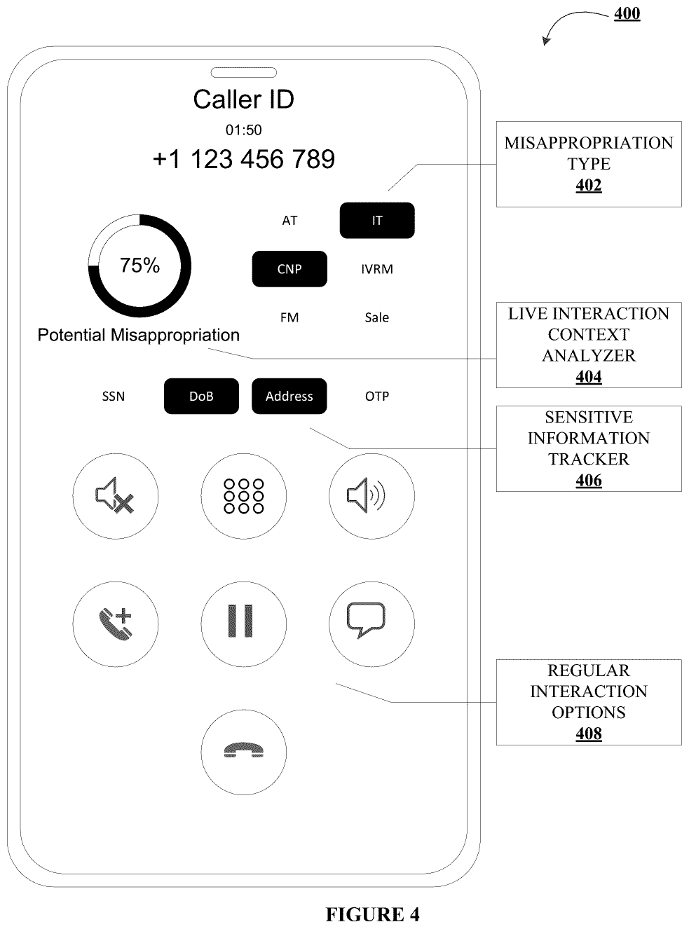

FIG. 4 is a process flow 400 which illustrates a process flow for an example application user interface, in accordance with example embodiments described herein. The method may be carried out by various components of the distributed computing environment 100 discussed herein (e.g., the system 130, or one or more end-point device(s) 140, etc.). An example system may include at least one processing device and at least one non-transitory storage device containing instructions that, when executed by the processing device, causes the processing device to perform the method discussed herein.

In some embodiments, a misappropriation system (e.g., similar to one or more of the systems described herein with respect to FIGS. 1A-1C) may perform one or more of the steps of process flow 400. For example, a misappropriation system (e.g., the system 130 described herein with respect to FIGS. 1A-1C) may perform the steps of process flow 400.

As shown in block 402, the process flow 400 of this embodiment includes a misappropriation type. In some embodiments, the misappropriation types may include an account takeover (AT), identity takeover (IT), card not present (CNP), interactive voice response (IVR) misappropriation, financial misappropriation (FM), sale, and/or the like. In some embodiments, the misappropriation type may show the type of misappropriation being attempted during the interaction. In some embodiments, the misappropriation determination system may determine one or more misappropriation types during the interaction. In some embodiments the misappropriation type may be updated in real time throughout the interaction.

As shown in block 404, the process flow 400 of this embodiment includes a live interaction context analyzer. In some embodiments, the live interaction context analyzer may execute the authorized set of rules in real time throughout the interaction. In some embodiments, in response to the authorized set of rules, the misappropriation determination system may update the live interaction context analyzer. In some embodiments, the live interaction context analyzer may represent the potential for a misappropriation through percentages (e.g., from 0% to 100%). For instance, and by way of non-limiting example, if the misappropriation determination system determines that there is a 32% chance that a misappropriation is occurring, the live interaction context analyzer may be updated to reflect that probability.

In another instance, and by way of non-limiting example, the live interaction context analyzer may represent misappropriations that may have taken place. For instance, and by way of non-limiting example, if the misappropriation determination system determines that there is a 52% chance that a misappropriation has occurred, the live interaction context analyzer may be updated to reflect that probability.

As shown in block 406, the process flow 400 of this embodiment includes a sensitive information tracker. In some embodiments, the sensitive information tracker may show the type of information the user has revealed during the interaction. For instance, and by way of non-limiting example, the sensitive information tracker may show the user has revealed the user's social security number (SSN), date of birth (DoB), address, one-time password (OTP), security code, security questions, security answers, driver's license number, and/or the like.

As shown in block 408, the process flow 400 of this embodiment includes regular interaction options. In some embodiments, the regular interaction options may reflect the options the user generally has during an interaction.

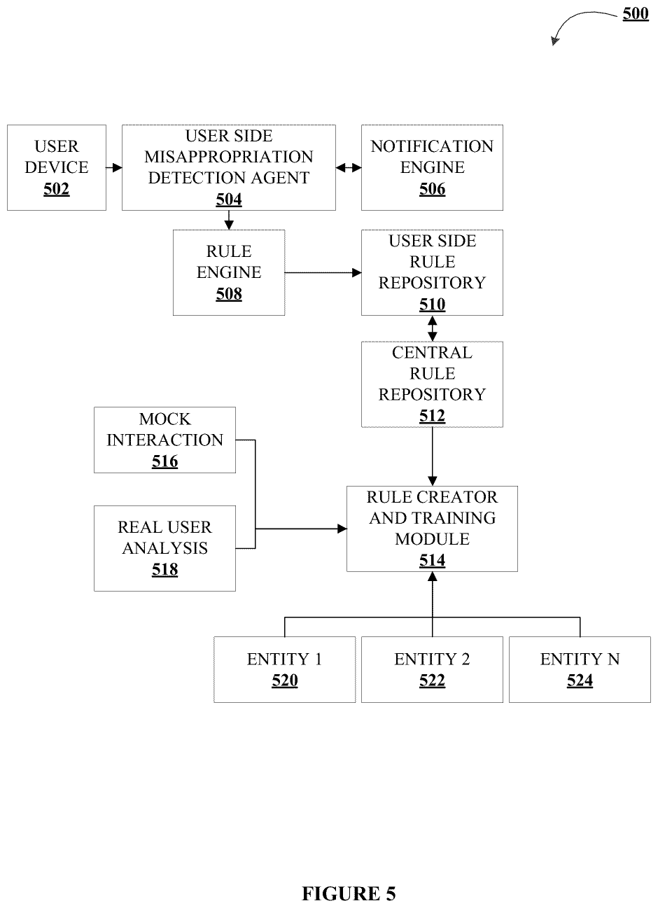

FIG. 5 is a process flow 500 which illustrates a process flow for an example process associated with example embodiments described herein. The method may be carried out by various components of the distributed computing environment 100 discussed herein (e.g., the system 130, or one or more end-point device(s) 140, etc.). An example system may include at least one processing device and at least one non-transitory storage device containing instructions that, when executed by the processing device, causes the processing device to perform the method discussed herein.

In some embodiments, a misappropriation system (e.g., similar to one or more of the systems described herein with respect to FIGS. 1A-1C) may perform one or more of the steps of process flow 500. For example, a misappropriation system (e.g., the system 130 described herein with respect to FIGS. 1A-1C) may perform the steps of process flow 500.

As shown in block 502, the process flow 500 of this embodiment includes a user device. In some embodiments, the user device may include the user device on which the user is performing the interaction. In some embodiments, the user device may be a different user (e.g., different than the one on which the user is performing the interaction).

As shown in block 504, the process flow 500 of this embodiment includes a user side misappropriation detection agent. In some embodiments, the user side misappropriation detection agent may include an artificial intelligence model, machine learning, natural language processing, and/or the like. In some embodiments, the user side misappropriation detection agent may be installed on the user device. In some embodiments, the user side misappropriation detection agent may determine a misappropriation during an interaction.

As shown in block 506, the process flow 500 of this embodiment includes a notification engine. In some embodiments, the notification engine may include transmitting notifications to the user device when the misappropriation determination system detects a misappropriation. In some embodiments, the notification engine may transmit notifications to the user throughout the interaction to update the user (e.g., via the user device) about the status of the interaction and any potential misappropriations.

As shown in block 508, the process flow 500 of this embodiment includes a rule engine. In some embodiments, the rule engine may include implementing the rules to the interaction. In some embodiments, the user side misappropriation detection agent and the rule engine may analyze the interaction with the rules received from the rule repositories. In this way, the rule engine may apply the rules to the interaction. In some embodiments, the user side misappropriation detection agent may select one or more portions of the interaction to transmit to the rule engine. In this way, the totality of the interaction may or may not be analyzed with the rule engine.

As shown in block 510, the process flow 500 of this embodiment includes a user side rule repository. In some embodiments, the user side rule repository may contain rules specific to the user. In some embodiments, the user side rule repository may contain rules specific to an entity associated with the user. In this way, the user side rule repository may contain rules (e.g., local rules) that may be used to analyze the interaction in response to the misappropriations detected in the interaction.

As shown in block 512, the process flow 500 of this embodiment includes a central rule repository. In some embodiments, the central rule repository may contain rules generally applicable to all interactions (e.g., global rules). In this way, the central rule repository may contain rules that are not specific to a particular misappropriation type, but generally applicable to all interactions. In some embodiments, the user side rule repository and the central rule repository may be synchronized through a rule synchronizer. In this way, the rule synchronizer may analyze the rules in each repository and transmit the applicable rule to the rule engine to apply to the interaction.

As shown in block 514, the process flow 500 of this embodiment includes a rule creator and training module. In some embodiments, the rule creator and training module may include rules submitted from one or more entities. In some embodiments, the rule creator and training module may include both global and local rules. In some embodiments, the rule creator and training module may include training data that may be fed into the artificial intelligence model that may indicate one or more misappropriations during an interaction.

As shown in block 516, the process flow 500 of this embodiment includes a mock interaction. In some embodiments, the mock interaction may include training information that may be used to train the artificial intelligence model. In some embodiments, the mock interaction may include a controlled interaction that includes predetermined requests and responses that may indicate a misappropriation. In some embodiments, the mock interaction may highlight certain phrases, keywords, questions, responses, and/or the lie which may indicate a misappropriation.

As shown in block 518, the process flow 500 of this embodiment includes real user analysis. In some embodiments, the real user analysis may include an uncontrolled interaction, wherein the uncontrolled interaction may be an actual interaction between a user and a caller that may be used as training data for the artificial intelligence model. In some embodiments, the real user analysis may be preprocessed to highlight certain phrases, keywords, questions, responses, and/or the like which may indicate a misappropriation.

In some embodiments, the real user analysis may include real-time data from an ongoing interaction. In this way, the misappropriation determination system may process the real-time data and feed it into the rule creator and training module. In this way, the misappropriation determination system may train the artificial intelligence model in real-time.

As shown in block 520, the process flow 500 of this embodiment includes entity 1. In some embodiments, the entity 1 may include an entity associated with the misappropriation determination system. In some embodiments, the entity 1 may include financial institutions, insurance institutions, government institutions, institutions associated with personal information of its users, and/or the like. In some embodiments, the entity 1 may alter, update, edit, maintain, manage, and/or the like the rule repositories.

As shown in block 522, the process flow 500 of this embodiment includes entity 2. In some embodiments, the entity 2 may include an entity associated with the misappropriation determination system. In some embodiments, the entity 2 may include financial institutions, insurance institutions, government institutions, institutions associated with personal information of its users, and/or the like. In some embodiments, the entity 2 may alter, update, edit, maintain, manage, and/or the like the rule repositories.

As shown in block 524, the process flow 500 of this embodiment includes entity N. In some embodiments, the entity N may include an entity associated with the misappropriation determination system. In some embodiments, the entity N may include financial institutions, insurance institutions, government institutions, institutions associated with personal information of its users, and/or the like. In some embodiments, the entity N may alter, update, edit, maintain, manage, and/or the like the rule repositories. In some embodiments, entity N may be any number of entities associated with the misappropriation determination system.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining resource misappropriation using an advanced computational model for data analysis and automated decision-making, the system comprising:
a processing device;
a non-transitory storage device containing instructions when executed by the processing device, causes the processing device to perform the steps of:
receive an interaction, wherein the interaction comprises a user and a caller;
determine an instance of misappropriation during the interaction using an artificial intelligence model, wherein the instance of misappropriation comprises the caller attempting to collect sensitive information associated with the user;
generate a misappropriation interface component, wherein the misappropriation interface component comprises data associated with the instance of misappropriation; and
notify the user of the instance of misappropriation.

2. The system of claim 1, wherein determining an instance of misappropriation further comprises:
monitoring the interaction, wherein monitoring the interaction comprises invoking a misappropriation detection module;
comparing the interaction with an interaction repository, wherein the interaction repository comprises an authorized set of rules; and
determining, in response to the caller attempting to collect sensitive information associated with the user, a misappropriation severity level.

3. The system of claim 2, wherein determining an instance of misappropriation further comprises determining a misappropriation type.

4. The system of claim 2, wherein the authorized set of rules comprises:
global rules, wherein the global rules comprise rules applicable to the interaction; and
local rules, wherein the local rules comprise rules applicable to certain misappropriation types.

5. The system of claim 2, wherein the authorized set of rules may be updated by one or more entities.

6. The system of claim 1, wherein receiving the interaction further comprises:
generating a finite state machine, wherein the finite state machine changes state in response to the misappropriation severity level;
restricting the user, wherein restricting the user comprises limiting the user's ability to continue with the interaction; and
generating a report, wherein the report comprises data associated with the interaction, and wherein the report is transmitted to an entity associated with the user.

7. The system of claim 1, wherein the misappropriation interface component further comprises configuring a graphical user interface associated with a user device.

8. A computer program product for determining resource misappropriation using an advanced computational model for data analysis and automated decision-making, the computer program product comprising a non-transitory computer-readable medium comprising code causing an apparatus to:
receive an interaction, wherein the interaction comprises a user and a caller;
determine an instance of misappropriation during the interaction using an artificial intelligence model, wherein the instance of misappropriation comprises the caller attempting to collect sensitive information associated with the user;
generate a misappropriation interface component, wherein the misappropriation interface component comprises data associated with the instance of misappropriation; and
notify the user of the instance of misappropriation.

9. The computer program product of claim 8, wherein determining an instance of misappropriation further comprises:
monitoring the interaction, wherein monitoring the interaction comprises invoking a misappropriation detection module;
comparing the interaction with an interaction repository, wherein the interaction repository comprises an authorized set of rules; and
determining, in response to the caller attempting to collect sensitive information associated with the user, a misappropriation severity level.

10. The computer program product of claim 9, wherein determining an instance of misappropriation further comprises determining a misappropriation type.

11. The computer program product of claim 9, wherein the authorized set of rules comprises:
global rules, wherein the global rules comprise rules applicable to the interaction; and
local rules, wherein the local rules comprise rules applicable to certain misappropriation types.

12. The computer program product of claim 9, wherein the authorized set of rules may be updated by one or more entities.

13. The computer program product of claim 8, wherein receiving the interaction further comprises:
generating a finite state machine, wherein the finite state machine changes state in response to the misappropriation severity level;
restricting the user, wherein restricting the user comprises limiting the user's ability to continue with the interaction; and
generating a report, wherein the report comprises data associated with the interaction, and wherein the report is transmitted to an entity associated with the user.

14. The computer program product of claim 8, wherein the misappropriation interface component further comprises configuring a graphical user interface associated with a user device.

15. A method for determining resource misappropriation using an advanced computational model for data analysis and automated decision-making, the method comprising:
receiving an interaction, wherein the interaction comprises a user and a caller;
determining an instance of misappropriation during the interaction using an artificial intelligence model, wherein the instance of misappropriation comprises the caller attempting to collect sensitive information associated with the user;
generating a misappropriation interface component, wherein the misappropriation interface component comprises data associated with the instance of misappropriation; and
notifying the user of the instance of misappropriation.

16. The method of claim 15, wherein determining an instance of misappropriation further comprises:
monitoring the interaction, wherein monitoring the interaction comprises invoking a misappropriation detection module;
comparing the interaction with an interaction repository, wherein the interaction repository comprises an authorized set of rules; and
determining, in response to the caller attempting to collect sensitive information associated with the user, a misappropriation severity level.

17. The method of claim 16, wherein determining an instance of misappropriation further comprises determining a misappropriation type.

18. The method of claim 16, wherein the authorized set of rules comprises:
global rules, wherein the global rules comprise rules applicable to the interaction; and
local rules, wherein the local rules comprise rules applicable to certain misappropriation types.

19. The method of claim 16, wherein the authorized set of rules may be updated by one or more entities.

20. The method of claim 15, wherein receiving the interaction further comprises:
generating a finite state machine, wherein the finite state machine changes state in response to the misappropriation severity level;
restricting the user, wherein restricting the user comprises limiting the user's ability to continue with the interaction; and
generating a report, wherein the report comprises data associated with the interaction, and wherein the report is transmitted to an entity associated with the user.
